(19) United States
(12) Patent Application Publication
(10) Pub. No.: US 2010/0045470 A1
(43) Pub. Date: Feb. 25, 2010

(54) STEAM DISTRIBUTION CONTROL SYSTEM AND METHOD FOR A STEAM HEATING SYSTEM

(76) Inventors: Steven P. ARAIZA, Malden, MA (US); Andrew J. BARTFAY-SZABO, North Andover, MA (US)

Correspondence Address: KED & ASSOCIATES, LLP, P.O. Box 221200, Chantilly, VA, 20153-1200, US

(21) Appl. No.: 12/544,364

(22) Filed: Aug. 20, 2009

Related U.S. Application Data
(63) Continuation-in-part of application No. 12/512,491.
(60) Provisional application No. 61/085,040, filed on Jul. 31, 2008.

(51) Int. Cl. G08B 21/00; F24D 1/02; F24D 19/10; G05D 7/06; G05D 23/19

(52) U.S. Cl. 340/603; 237/9 R; 237/73; 700/282; 700/300

(57) ABSTRACT

A steam distribution control system and method for a steam heating system are provided. The steam heating system may include a plurality of radiators, a boiler that provides steam to the plurality of radiators, and a plurality of steam pipes that carry the steam to the plurality of radiators, respectively. The steam distribution control system may include a plurality of steam-air vents provided at the plurality of radiators, respectively, and a central controller in communication with the plurality of steam-air vents that selectively controls the plurality of steam-air vents to control an amount of steam distributed into each of the plurality of radiators. The method may include providing a steam-air vent at each of the plurality of radiators, and selectively controlling the plurality of steam-air vents to control an amount of steam distributed into each of the plurality of radiators.

This application is a Continuation-In-Part of U.S. patent application Ser. No. 12/512,491, filed Jul. 30, 2009, which claims priority to U.S. Provisional Application No. 61/085,040, filed Jul. 31, 2008. These applications are hereby incorporated by reference.

### BACKGROUND

1. Field

A steam distribution control system and method for a steam heating system are disclosed herein.

2. Background

Steam heating systems are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a schematic diagram of a steam distribution control system for a steam heating system according to an embodiment;

FIG. 2 is a schematic diagram of the central controller of FIG. 1;

FIG. 3A is a front view of a steam-air vent according to an embodiment;

FIG. 3B is a side view of the steam-air vent of FIG. 3A;

FIG. 3C is a schematic diagram of electronics of the steam-air vent of FIG. 3A;

FIG. 4A is an exploded front view of a steam-air vent according to another embodiment;

FIG. 4B is an assembled front view of the steam-air vent of FIG. 4A;

FIG. 5 is a schematic diagram of a steam distribution control system for a steam heating system according to another embodiment;

FIG. 6 is a schematic diagram of a steam distribution control system for a steam heating system according to another embodiment;

FIG. 7 is a schematic diagram of a steam distribution control system for a steam heating system according to another embodiment;

FIG. 8 is a flow chart of a steam distribution control method for a steam heating system according to an embodiment;

FIG. 9 is a flow chart of a steam distribution control method for a steam heating system according to another embodiment;

FIG. 10 is a flow chart of a steam distribution control method for a steam heating system according to according to another embodiment;

FIG. 11 is a flow chart of a steam distribution control method for a steam heating system according to according to another embodiment;

FIG. 12 is a flow chart of a steam distribution control method for a steam heating system according to according to another embodiment; and

FIG. 13 is a flow chart of an installation method for a steam distribution control system according to an embodiment.

### DETAILED DESCRIPTION

Embodiments of a steam distribution control system and method for a steam heating system are described in detail with reference to the accompanying drawings. Where possible, like reference numerals have been used to refer to like elements, and repetitive disclosure has been omitted.

Many older homes, apartment buildings, and commercial buildings may employ steam heating systems, for example, single-pipe steam heating systems. Such heating systems may employ gas or oil-fired boilers to supply steam to a plurality of radiators distributed throughout the building. One disadvantage of such systems is uneven heat distribution. An apartment building, for example, may have the heat adjusted according to needs of a coldest unit (for example, a unit that is most difficult to heat) causing other units to be over-heated. Tenants in the over-heated units may open windows to compensate. This is a costly and grossly inefficient means of heat balancing. The unfortunate results are a significant waste of fuel, increased pollution, and compromised comfort of the building inhabitants.

A complete replacement of a building's steam-heat system is typically cost prohibitive. Less dramatic remedies exist, but these are marginally effective and difficult to install and adjust.

In a single-pipe steam heating system, a boiler may heat water into steam under the control of a single thermostat. The steam may rise up through a plurality of pipes to a plurality of radiators. After the steam transfers its heat through a radiator into a room, the steam may condense back into water and drip down the same pipe, through which it rose, back to the boiler.

Each radiator may have a steam-air vent or steam inlet valve on one end, and a steam-air outlet valve on the other end. The steam-air vent may be, for example, a small hole in the radiator. The distribution of steam, and thus heat, may be determined by relative sizes of the steam-air vent holes. If a radiator has a large steam-air vent hole, more steam will enter that radiator than will enter a radiator having a smaller vent hole. The process of adjusting the sizes of the individual vent holes is called balancing. This is, for a vast majority of steam heating systems, a manual process based on intuition and rule of thumb.

The steam distribution control system and method for a steam heating system according to embodiments disclosed herein may provide, for example, the following features: automatic and dynamic radiator balancing; distributed temperature sensing; system-level intelligent and adaptive control; data logging for offline energy efficiency and operation analysis; remote, real-time status monitoring and control; real-time fault notification via the Internet or telephone.

The steam distribution control system according to embodiments disclosed herein may include a central controller, a plurality of distributed temperature sensors, and a novel steam-air vent for each radiator. The steam distribution control system according to embodiments disclosed herein may also include one or more thermostats. The central controller may monitor the plurality of temperature sensors and/or one or more thermostats, and intelligently control the boiler and each radiator's steam-air vent. The central controller may maintain comfortable heat levels based on user desired temperature settings or schedules and optimize the boiler's energy usage. Further, the central controller may recognize and alert users to excessive heat-use situations, such as those caused by open windows and propped doors.

The steam distribution control system according to embodiments disclosed herein may further include a boiler switch for the boiler. The central controller may intelligently control the boiler switch.

Further, the one or more thermostats are optional. When omitted, user interface may be provided solely by or at the central controller.

Communication between the central controller and the individual components may be via, for example, a low-power, wireless mesh network, such as, for example, ZigBee or Z-Wave. This type of network requires little electrical power, and thus, facilitates battery powered operation of the various devices of the system. The central controller may include connection(s) to telephone, Internet, and/or Bluetooth.

The plurality of steam-air vents, the plurality of temperature sensors, and/or the one or more thermostats may be battery powered, and may communicate wirelessly with the central controller via the wireless mesh network. The only wiring required by the steam distribution control system may be that between the boiler and boiler switch.

Software items for the system may include, for example, controller software, bluetooth cellular phone software (optional), and desktop software.

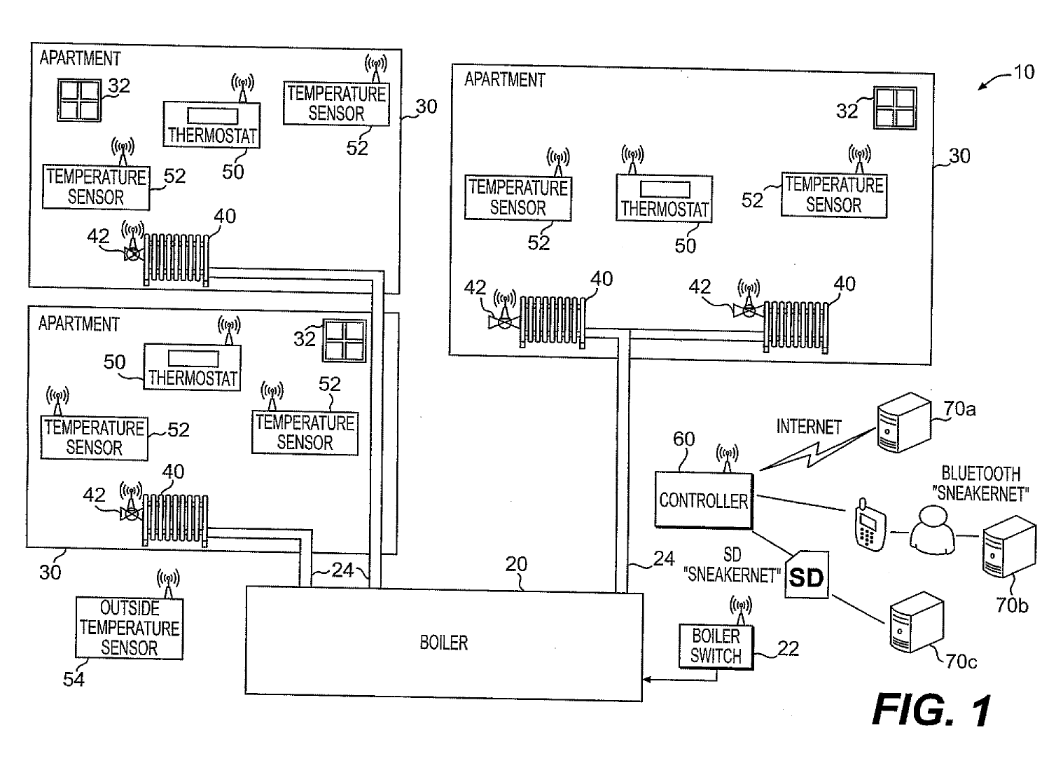

FIG. 1 is a schematic diagram of a steam distribution control system for a steam heating system according to an embodiment. The steam distribution control system of FIG. 1 may be retrofitted or adapted for an existing steam heating system. FIG. 1 shows a single-pipe steam heating system retrofitted with the steam distribution control system according to an embodiment. However, one of ordinary skill in the art will recognize that the steam distribution control system according to embodiments disclosed herein may be adapted for other types of steam heating systems as well.

FIG. 1 shows a plurality of exemplary apartments 30 of an exemplary building, each apartment 30 having one or more radiators 40 disposed therein. Each apartment 30 may also have one or more window(s) 32. Each of the plurality of radiators 40 in the apartments 30 may be in communication with a boiler 20 via a steam pipe 24, by which the boiler 20 may supply the radiator 40 with steam. The boiler 20 may include a boiler switch 22 by which the boiler 20 may be turned on or off.

The steam distribution control system 10 of FIG. 1 may include a central controller 60, a plurality of indoor temperature sensors 52 distributed throughout the apartments 30, and a steam-air vent 42 for each radiator 40. The steam distribution control system 10 may further include one or more outdoor temperature sensor(s) 54. Additionally, the steam distribution control system 10 may include one or more thermostat(s) 50. The steam-air vent 42 will be described in more detail hereinafter.

The central controller may wirelessly communicate with the plurality of steam-air vents 42, the plurality of indoor temperature sensors 52, the one or more outdoor temperature sensor(s) 54, the one or more thermostat(s) 50, and/or the boiler switch 22. That is, a wireless mesh network, such as ZigBee or Z-wave, may be provided for communication between the central controller 60 and the plurality of steam-air vents 42, the plurality of indoor temperature sensors 52, the one or more outdoor temperature sensor(s) 54, and/or the one or more thermostat(s) 50.

The central controller 60 may be configured to selectively control the plurality of steam-air vents 42 to control an amount of steam distributed into each of the plurality of radiators. That is, the central controller 60 may be configured to control each of the steam-air vents 42 to control a flow of steam into each radiator 42. This may be accomplished by opening and closing the steam-air vent 42 to control the flow of steam into the radiator 42, or by controlling an opening amount of an orifice of the steam-air vent 42 to control the flow of steam into the radiator 40.

The steam distribution control system 10 may include the one or more thermostat(s) 50 distributed throughout the apartments 30, which may provide one or more user interface(s) with the steam distribution control system 10. Alternatively, a user interface may be provided solely at the central controller 60.

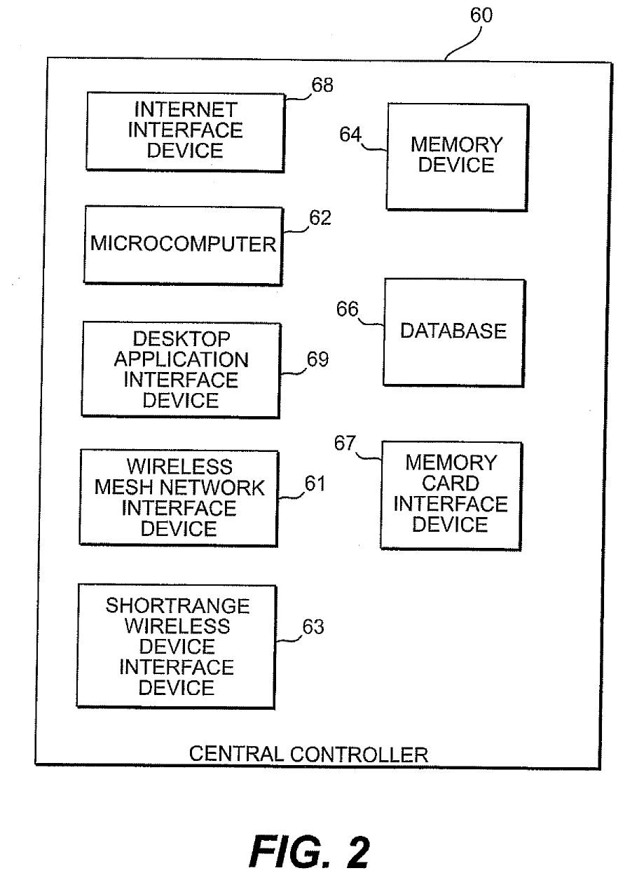

As shown in FIG. 2, the central controller 60 may include a microcomputer 62, a wireless mesh network interface device or component 61, a memory device or component 64, a database 66, and a desktop application interface device or component 69. The wireless mesh network interface device 61 allows the central controller 60 to wirelessly communicate with the plurality of steam-air vents 42, the plurality of temperature sensors 30, the one or more thermostat(s) 50, and/or the boiler switch 22, as discussed above. The database 66 may be provided, in which data is stored. The memory device 64 may be provided to store data collected, for example, for each boiler cycle. The desktop application interface device 69 allows the central controller 60 to interface with a desktop application on a computer 70.

Further, the central controller 60 may include an Internet interface device or component 68, which provides the central controller 60 with access to the Internet, a short range wireless device interface device or component 63, such as Bluetooth, which allows the central controller 60 to communicate with another device, such as a mobile phone, having such capability, and/or a memory card interface device or component 63, which allows the central controller 60 to communicate with a memory card, such as a secure digital (SD) card or USB memory stick, to upload data therefrom or download data thereto.

A backup central controller (not shown) may be provided in case of malfunction or failure of the central controller 60. Alternatively, the system may be configured so that the steam heating system reverts back to pre-existing control means in the case of malfunction or failure of the central controller.

As set forth above, the plurality of temperature sensors 30, the one or more thermostat(s) 50, and/or the plurality of steam-air vents 42 may communicate with the central controller 60 via a wireless mesh network. In such a case, the only required wiring may be that between the boiler 20 and the boiler switch 22.

The plurality of temperature sensors 30 provide the central controller 60 with sensed temperatures at various locations. Using the sensed temperatures provided by the plurality of temperature sensors 30, the central controller 60 may selectively control the plurality of steam-air vents 42 to control the distribution of steam to the plurality of radiators 40.

For example, the steam distribution control system 10 may divide a building into multiple, uniquely and/or individually controlled zones. A zone may be, for example, one room, many rooms, an entire apartment, an entire floor of the building, or another configuration.

Each zone may have one or more temperature sensors 52 and/or one or more thermostat(s) 50. Temperature sensors may be provided in un-controlled areas (for example, un-heated areas and outdoors), as well. For example, outdoor temperature sensor 54 may be provided. Coverage of the building with temperature sensors facilitates optimized control, efficiency, and fault detection.

A unique target temperature for each zone may be controlled by a respective temperature schedule. The temperature schedules may be managed by the central controller 60. The temperature schedules may be set through a remote desk-top application in communication with the central controller, a built-in webserver, or via the optional thermostats. With respect to this embodiment, it is noted that while a thermostat may be used to configure a temperature schedule, it may not directly control the boiler or a zone's steam-air vents. All of the control may be central to the central controller 60.

When one or more zones requires heat, the central controller 60 may turn on the boiler 20 via the boiler switch 22, starting a boiler cycle. Throughout the boiler cycle, the central controller 60 may uniquely manipulate each steam-air vent 42 to achieve a desired heating behavior. All of the steam-air vents 42 in a zone may be opened and closed or varied in unison, under the direction of the central controller 60. Alternatively, the steam-air vents 42 in a zone may be individually and selectively controlled by the central controller 60 to obtain the desired heating behavior.

The central controller 60 may characterize a thermodynamic behavior of the zones and/or of the building as a whole, and periodically adapt its algorithms to optimize operation. For example, a zone calling for heat, which is situated above another zone also calling for heat, may be shut off early, in expectation of the additional heat that will rise from the lower zone. Similarly, a zone whose temperature after a boiler cycle decreases a little or not at all (due to, for example, solar heat absorption) may have its steam reduced or removed completely for the next boiler cycle. The control algorithms may adapt to such contingencies using various means, one example being dynamic computation of unique heating coefficients for each zone. This parameter is basically a correlation of steam usage and heat rise over time, and may be dynamically re-computed to account for an outdoor temperature and temperatures of adjoining zones. The heating coefficients allow the steam distribution control system according to embodiments disclosed herein to predict a rate of heat rise of a zone in any situation, and thus, ensure that zones reach their target temperatures simultaneously, avoiding over-heating.

Thus, the central controller 60 may monitor the temperature sensors 52, the temperature sensor(s) 54, and/or the thermostats 50 and control the steam-air vents 42 and/or the boiler switch 22 to obtain the desired heating behavior for the one or more zones and/or the building as a whole. The central controller 60 may continuously monitor the heating profile(s) of the one or more zone(s) and/or the building as a whole, and compute updated solutions based on the sensed temperatures and desired temperature schedules for each of the one or more zones and/or the building as a whole.

Experiments conducted by the Inventors have shown that closing a vent on an already hot radiator may not significantly coot a radiator throughout a remainder of a boiler cycle. On the other hand, starting the boiler cycle with the vent closed may prevent steam from entering the radiator until the vent is opened.

Since a hot radiator may not be cooled during the boiler cycle, the steam distribution control system and method according to embodiments disclosed herein may instead delay heating of a radiator by delaying opening of the vent of the radiator. An amount of delay time applied to a zone's radiators may be a function of that zone's heating coefficient and temperature set point(s).

Steam heating systems, especially older ones, have reliability issues. The reliability issues may be caused, for example, by boiler burner clogs, water and steam leak, obscured radiators, and other occurrences that may compromise system operation. Misuse and tampering may also be problematic. Factors external to the steam heating system may adversely affect heating effectiveness and efficiency, as well, such as open windows and doors.

The central controller 60 may include configurable monitors that detect, for example, failures or misuse, and may issue a warning or alert. The resulting warning or alert may be transmitted as, for example, emails or text messages to a user or administrator, in addition to being stored in the memory device 64. Further, the warning or alert may include impending maintenance needs or instructions, a record of which may also be stored in the memory device 64.

The central controller 60 may dynamically compute a heating coefficient for each zone. Before every boiler cycle, the central controller 60 may predict a zone's heat rise according to its coefficient. Open windows may cause a deviation from the predicted behavior. The central controller 60 may detect the deviation and issue an alert.

An area need not be heated to have predictable behavior. For example, a zone need not have a radiator receiving steam to have predictable behavior, as it will receive heat from adjoining zones. Thus, a temperature sensor in an unheated area may be utilized to influence distribution of steam by the steam distribution control system and method according to embodiments disclosed herein. This may allow the steam distribution control system and method according to embodiments disclosed herein to detect, for example, a propped door in an unheated lobby or entry area.

All events may be logged and stored within the central controller 60, for example, in the memory device 64. This may include temperature data, alerts, the turning on and off of the boiler, the opening and closing or varying of the vent openings of the steam-air vents, and temperature set point changes. The log data may be transferred to a computer of, for example, a user or an administrator, such as a building's superintendent, for analysis by a desktop application as discussed herein below.

The desktop application may allow a user or administrator to remotely examine and analyze log data, adjust the steam distribution control system configuration and programming, and add components to extend the steam distribution control system. The desktop application may connect to the central controller 60 through various means, for example, a direct Internet connection, a memory card, or a short range wireless connection. A memory card, such as a SD card or USB memory stick, may be used to transfer data between the central controller 60 and a computer containing the desktop application. The central controller 60 may read new programming data from the memory card, and put data on the memory card that is destined for the desktop application.

The short range wireless connection may be, for example, a smartphone and Bluetooth wireless link, employed for data transfer. A smartphone application may be provided that includes some subset of the desktop application's features.

Each of the individual devices or components of the steam distribution control system according to embodiments disclosed herein may be battery powered where permissible. This results in a low power and/or low cost control system.

The steam-air vent 42 may be a type of steam-air vent that merely opens and closes a vent opening. With such a configuration, the central controller 60 would control the steam-air vent 42 to selectively open and close the steam-air vent to control an amount of steam that follows into the respective radiator 40. Alternatively, the steam-air vent 42 may be a type of steam-air vent that varies a vent opening amount to vary a flow rate of steam. With such a configuration, the central controller 60 would control a vent opening amount of the steam-air vent 42 to control a flow rate of steam into the respective radiator 40. In either case, the central controller 60 may selectively control the plurality of steam-air vent 42 to control an amount of steam distributed into each of the plurality of radiators 40.

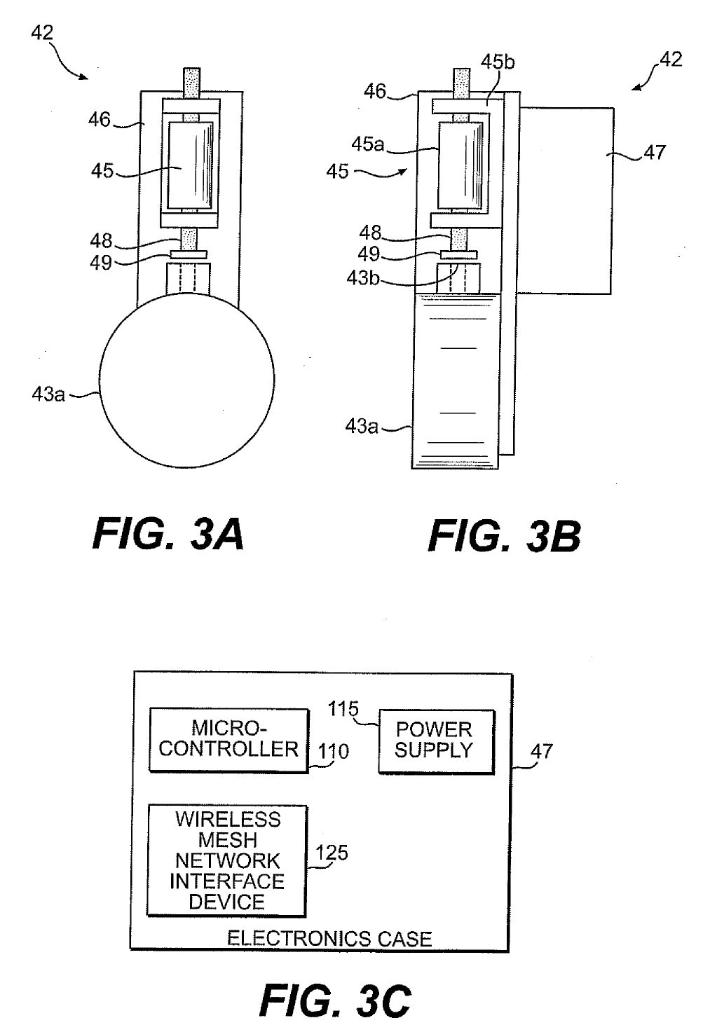

An example of a type of steam-air vent that opens and closes a vent opening is shown in FIGS. 3A-3C. The steam-air vent 42 of FIG. 3 may include, for example, a Jacobus Maid-O-Mist vent; however, other types of vents may also be appropriate. Further, the steam-air vent 42 may include a means to prohibit the escape of water and steam from the radiator. The example of FIGS. 3A-3C includes a Jacobus Maid-o-Mist vent for this purpose; however, other types of vents may be appropriate. A Jacobus vent in particular is not a required part of the invention. Any means that provides the same function, i.e. water and steam entrapment, is sufficient. The steam distribution control system-specific electronics and mechanical components may be attached to and augment the Jacobus or other type vent.

As shown in FIG. 3, the steam-air vent 42 may include a latching (magnetically latching, mechanically latching, or otherwise) solenoid as a valve. This type of solenoid requires no energy to stay in either the open or closed state, which facilitates battery powered operation. Alternatively, a DC motor or stepper motor may be used instead of a solenoid.

The exemplary steam-air vent of FIG. 3 includes a vent main body 43a, a vent opening 43b, a vent cover 49, a shaft 48, a solenoid 45, a cover 46, and an electronics case 47. As set forth above, the vent main body 43a may be a Jacobus Maid-O-Mist vent, or another similar type vent. Within the electronics case 47, a microcontroller 110, a power supply 115, for example, a battery, and a wireless mesh network interface device or component 125 may be provided. The wireless mesh network interface device 125 and the microcontroller 110 may be combined into a single component.

The central controller 60 communicates with the microcontroller 110 via the wireless mesh network interface device 125 to control the steam-air vent 42, selectively opening and closing the vent opening 44 by activating and de-activating the solenoid 45.

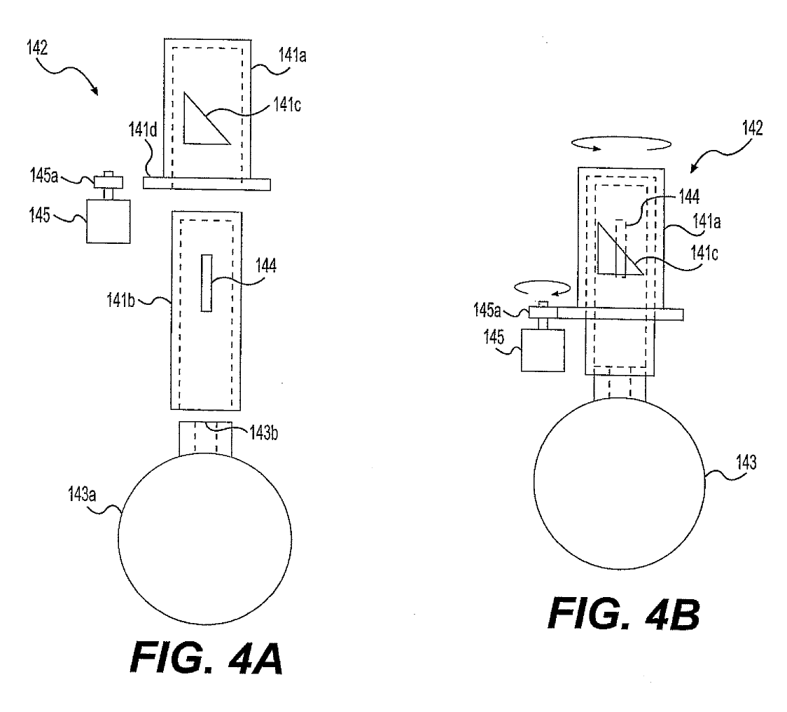

An example of a type of steam-air vent that varies a vent opening amount is shown in FIGS. 4A-4B. The electronics for the steam-air vent of FIGS. 4A-4B would be similar to that of the embodiment of FIGS. 3A-3C, and thus, repetitive disclosure has been omitted.

FIG. 4A is an exploded front view of a steam-air vent according to another embodiment. FIG. 4B is an assembled front view of the steam-air vent of FIG. 4A.

The steam-air vent 142 of FIGS. 4A-4B includes a vent main body 143a, a first vent opening 144 formed in a wall of an inner cylinder 141b attached to the main vent body 143a, and an outer cylinder 141a in which the inner cylinder 141b is disposed. As set forth above, the vent main body 143a may be a Jacobus Maid-O-Mist Vent, or another similar type vent. A second vent opening 141c is provided in a wall of the outer cylinder 141a. A motor 145 is provided, which rotates the outer cylinder 141a with respect to the inner cylinder 141b, by means of, for example, gear 145a and 141d, allowing the first vent opening 144 and the second vent opening 141c to overlap to a variable degree. The amount of the first opening 144 of the inner cylinder 141b that is exposed by the second vent opening 141c of the outer cylinder 141a controls the amount of venting allow by the steam-air vent 142.

The first vent opening 144 is shown with respect to this embodiment in the shape of a slot; however, other shapes may also be appropriate. Further, the second vent opening 141c is shown with respect to this embodiment as triangular in shape; however, other shapes may also be appropriate.

The steam distribution control system according to embodiments disclosed above provides a high degree of control and allows management of an entire building. However, one of ordinary skill in the art will recognize that the steam distribution control system according to embodiments disclosed herein may be configured to address simpler applications.

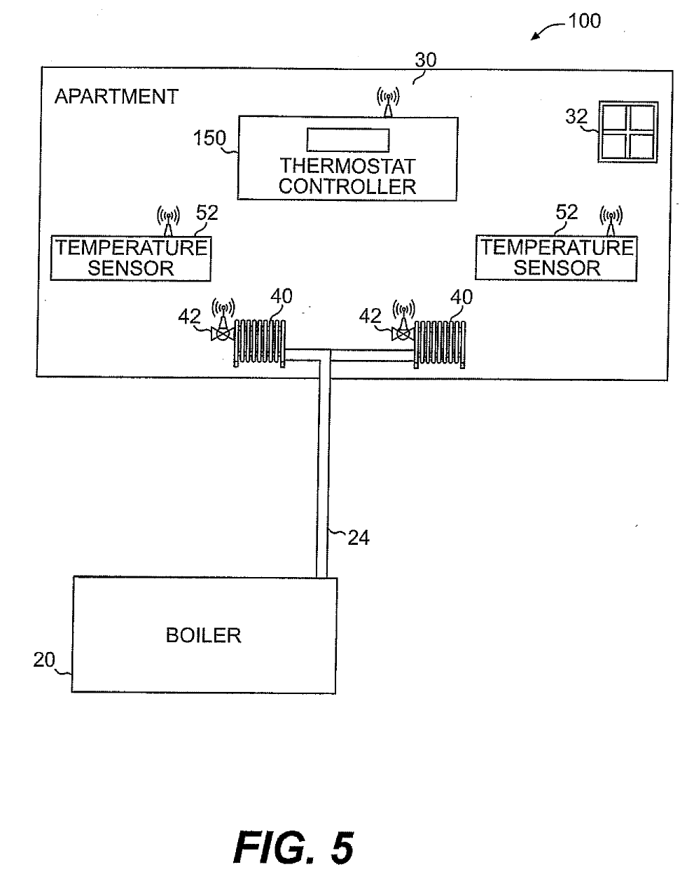

FIG. 5 is a schematic diagram of a steam distribution control system for a steam heating system according to another embodiment. The steam distribution control system of FIG. 5 may be retrofitted or adapted for an existing steam heating system. FIG. 5 shows a single-pipe steam heating system retrofitted with the steam distribution control system according to this embodiment. However, one of ordinary skill in the art will recognize that the steam distribution control system according to embodiments disclosed herein may be adapted for other types of steam heating systems as well. The embodiment of FIG. 5 is directed to controlling steam distribution within a single zone, for example, an apartment. Like reference numerals have been used to indicate like elements, and repetitive disclosure has been omitted.

That is, the steam distribution control system according to this embodiment may manage heating of only a single zone, for example, an apartment, and may not control the boiler. The steam distribution control system according to this embodiment may employ one or more steam-air vents 42 controlled by a combination thermostat-controller 150. The steam distribution control system of this embodiment is similar to a Thermostatic Radiator Valve (TRV), which is a steam-air vent that adjusts to its location's temperature.

A TRV senses a temperature just inches from a radiator to which it is attached or a few feet away using a wired temperature probe. Thus, a TRV cannot accurately determine a zone's heating requirement. The steam distribution control system according to this embodiment, on the other hand, may sense a temperature at the thermostat-controller 150 and/or temperature sensors 52. The thermostat-controller 150 may communicate with the steam-air vents 42 wirelessly.

The distributed temperature sensing of the embodiments disclosed herein may alleviate problems associated with a single, centrally located thermostat and/or a temperature sensor located immediately adjacent to a radiator. For example, the location of a single thermostat may not well represent the temperature of, for example, an entire apartment or building, as its location may become over or under-heated due to, for example, usage and/or weather conditions. Further, a malfunctioning or misused thermostat may upset the heating of the entire apartment or building.

Locating a thermostat in a central location implies that the location must be heated even if it is uninhabited. For example, a foyer of an apartment or a lobby of an apartment building is a common location for a thermostat. The foyer or lobby loses heat through entry doors, windows, and stairwells. Sensing temperatures within living areas instead allows the heat distributed to a central location to be reduced or completely removed, providing a significant energy savings.

The steam distribution control system 100 of FIG. 5 includes a plurality of steam-air vents 42 provided for a plurality of radiators 40 within the designated zone, in FIG. 5 apartment 30. A plurality of temperature sensors 52 are distributed through the zone, along with one or more thermostat-controller(s) 150. The one or more thermostat-controller(s) 150 function as a user interface, through which a user may set a desired temperature schedule for the zone(s). The one or more thermostat-controller(s) 150 then control the plurality of steam-air vents 42 to control an amount of steam distributed to the plurality of radiators 40 based on the user set temperature schedule and temperatures sensed by the plurality of distributed temperature sensors 52. In this embodiment, the one or more thermostat-controller(s) 150 function similar to the central controller 60 of the embodiment of FIG. 1.

Similar to the embodiment of FIG. 1, the thermostat-controller(s) 150 continuously monitors the sensed temperatures and controls the steam-air vents 42 to obtain a desired heating behavior for the zone. The thermostat-controller(s) 150 continuously monitors the heating profile of the zone, and computes updated solutions based on the sensed temperatures and desired temperature schedules set for the zone.

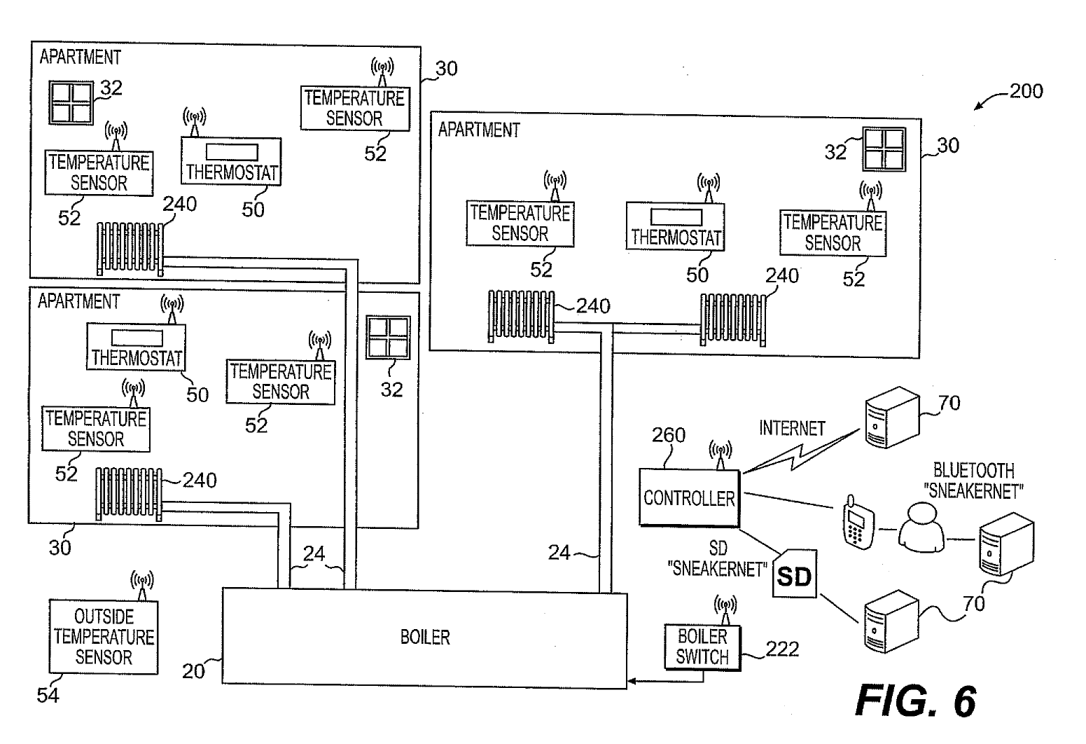

FIG. 6 is a schematic diagram of a steam distribution control system for a steam heating system according to another embodiment. The steam distribution control system of FIG. 6 may be retrofitted or adapted for an existing steam heating system. FIG. 6 shows a single-pipe steam heating system retrofitted with the steam distribution control system according to this embodiment. However, one of ordinary skill in the art will recognize that the steam distribution control system according to embodiments disclosed herein may be adapted for other types of steam heating systems as well. The embodiment of FIG. 6 is similar to the embodiment of FIG. 1, except this embodiment does not utilize the plurality of steam-air vents. Instead, the central controller 260, in response to a user set temperature schedule and temperatures sensed by the plurality of temperature sensors 52, selectively controls distribution of steam to the plurality of radiators 240 by controlling the boiler switch 222, that is, turning on and off the boiler switch. Like reference numerals have been used to indicate like elements, and repetitive disclosure has been omitted.

Similar to the embodiment of FIG. 1, the central controller 260 continuously monitors the temperature sensors 52, the temperature sensor 54, and/or the thermostats 50, and controls the boiler switch 222 to obtain a desired heating behavior for the one or more zone(s). The central controller 260 continuously monitors the heating profile(s) of the one or more zone(s), and computes updated solutions based on the sensed temperature and desired temperature schedules for each of the one or more zone(s).

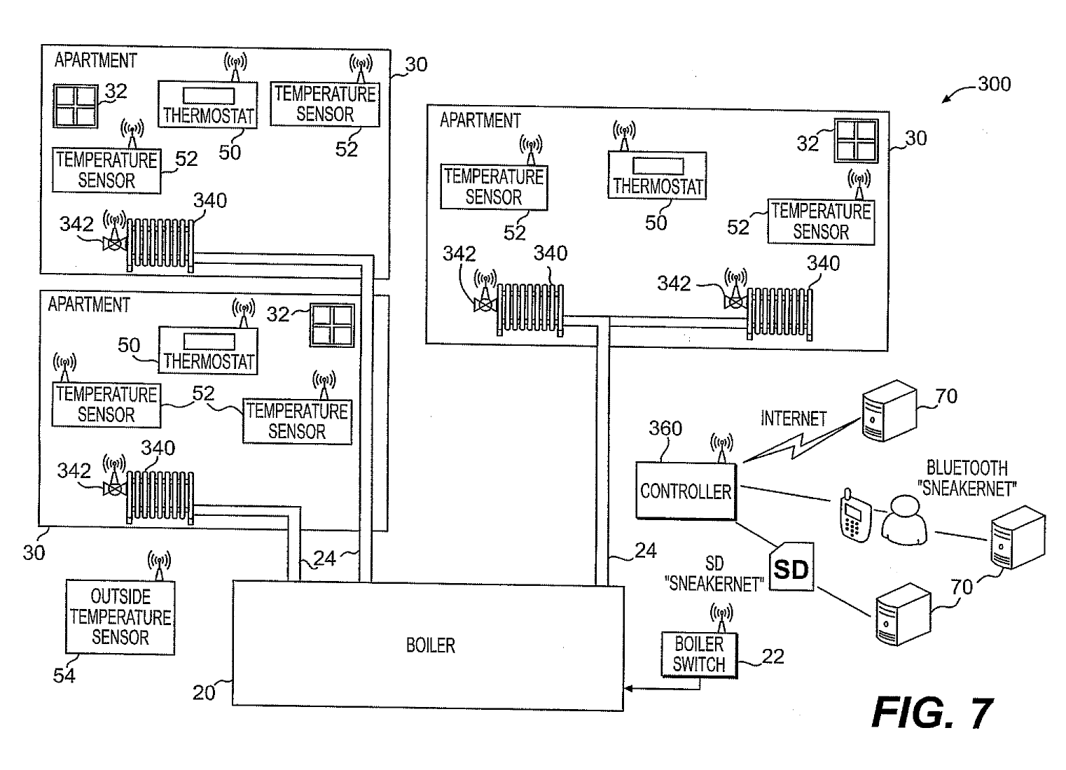

FIG. 7 is a schematic diagram of a steam distribution control system for a steam heating system according to another embodiment. The steam distribution control system of FIG. 7 may be retrofitted or adapted for an existing steam heating system. FIG. 7 shows a single-pipe steam heating system retrofitted with the steam distribution control system according to this embodiment. However, one of ordinary skill in the art will recognize that the steam distribution control system according to embodiments disclosed herein may be adapted for other types of steam heating systems as well. The embodiment of FIG. 7 is similar to the embodiment of FIG. 1; however, the embodiment of FIG. 7 utilizes a novel type of steam-air vent 342 that includes a pump. The pump is employed to evacuate air from the radiator 40 and maximize the steam volume within the radiator 40. Like reference numerals have been used to indicate like elements, and repetitive disclosure has been omitted.

Under-sized radiators, radiators fed by undersized pipes, and radiators far from the boiler 20 often may not accept enough steam to adequately heat their area, even with a fully open steam-air vent. To compensate, users often increase the output of adjacent radiators, over-heating one space to satisfy another. A pump-equipped steam-air vent 342 may increase a radiator's affinity for steam by creating a partial vacuum that draws steam actively into the radiator. The central controller 360 of FIG. 7 may vary a period of time the pumps of the plurality of the steam-air vents 342 of a zone are active during a boiler cycle in order to adequately heat the zone.

The plurality of steam-air vents 342 may be driven by an electric motor (not shown). Thus, power may be drawn from AC mains, a rechargeable battery pack, or from energy scavenged from the radiator, for example, with a thermoelectric generator.

Similar to the embodiment of FIG. 1, the central controller 360 continuously monitors the temperature sensors 52, the temperature sensor 54, and/or the thermostats 50, and controls the steam-air vent 342 to obtain a desired heating behavior for the one or more zone(s). The central controller 360 continuously monitors the heating profile(s) of the one or more zone(s), and computes updated solutions based on the sensed temperature and desired temperature schedules set for each of the one or more zone(s).

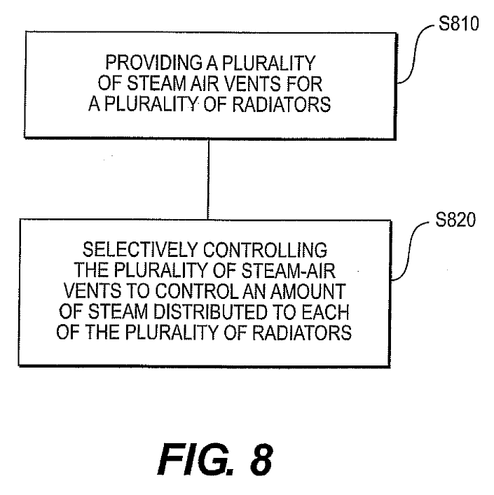

FIG. 8 is a flow chart of a steam distribution control method for a steam heating system according to an embodiment. The steam distribution control method of FIG. 8 may be retrofitted or adapted for an existing steam heating system, which may include a plurality of radiators, a boiler that provides steam to the plurality of radiators, and a plurality of steam pipes that carry the steam to the plurality of radiators, respectively. The method of FIG. 8 includes providing each of the plurality of radiators with a steam-air vent, in step S810, and selectively controlling the plurality of steam-air vents to control an amount of steam distributed to each of the plurality of radiators, in step S820.

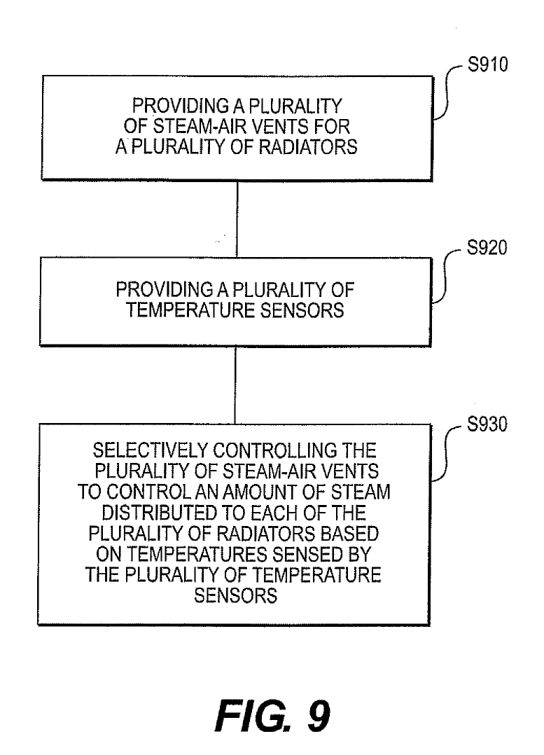

FIG. 9 is a flow chart of a steam distribution control method for a steam heating system according to another embodiment. The steam distribution control method of FIG. 9 may be retrofitted or adapted for an existing steam heating system, which may include a plurality of radiators, a boiler that provides steam to the plurality of radiators, and a plurality of steam pipes that carry the steam to the plurality of radiators, respectively.

The method of FIG. 9 includes providing each of the plurality of radiators with a steam-air vent, in step S910, providing a plurality of temperature sensors, in step S920, and selectively controlling the plurality of steam-air vents to control an amount of steam distributed to each of the plurality of radiators based on temperatures sensed by the plurality of temperature sensors, in step S930. Step S930 involves continuously monitoring the plurality of temperature sensors and selectively controlling the plurality of steam air vents based on the sensed temperatures and a temperature schedule set by a user for a predetermined zone(s) in which the plurality of radiators are provided, to obtain a desired heating behavior for the zone(s), as discussed above with respect to the steam distribution control system according to embodiments disclosed herein.

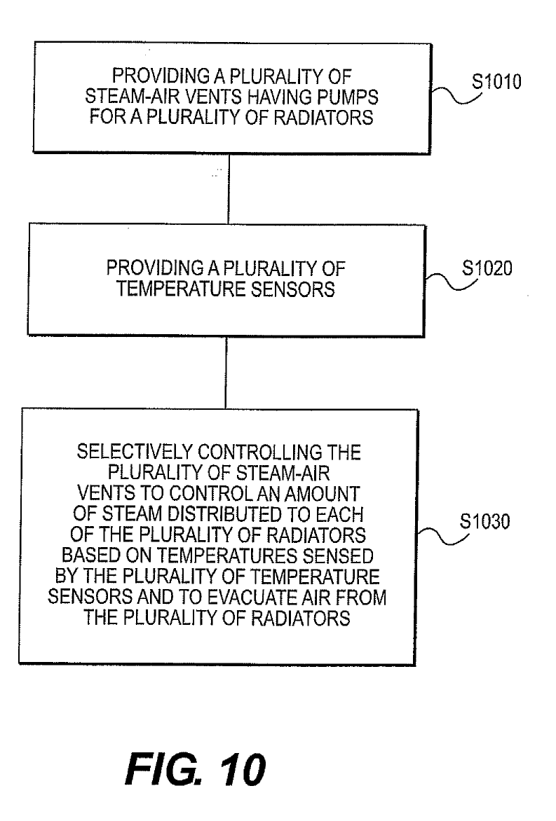

FIG. 10 is a flow chart of a steam distribution control method for a steam heating system according to another embodiment. The steam distribution control method of FIG. 10 may be retrofitted or adapted for an existing steam heating system, which may include a plurality of radiators, a boiler that provides steam to the plurality of radiators, and a plurality of steam pipes that carry the steam to the plurality of radiators, respectively.

The method of FIG. 10 includes providing each of the plurality of radiators with a steam-air vent having a pump, in step S1010, providing a plurality of temperature sensors, in step S1020, and selectively controlling the plurality of steam-air vents to control an amount of steam distributed to each of the plurality of radiators based on temperatures sensed by the plurality of temperature sensors and to evacuate air from the plurality of radiators, in step S1030. Step S1030 involves continuously monitoring the plurality of temperature sensors and selectively controlling the plurality of steam first air vents and the plurality of second steam-air vents based on the sensed temperatures and a temperature schedule set by a user for a predetermined zone(s) in which the plurality of radiators are provided, to obtain a desired heating behavior for the zone(s), as discussed above with respect to the steam distribution control system according to embodiments disclosed herein.

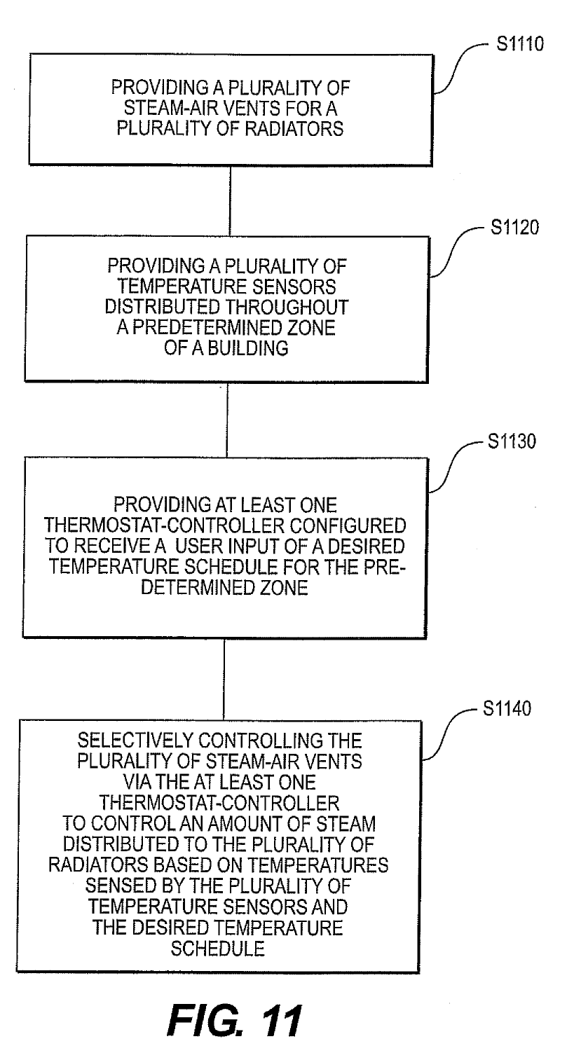

FIG. 11 is a flow chart of a steam distribution control method for a steam heating system according to another embodiment. The steam distribution control method of FIG. 11 may be retrofitted or adapted for an existing steam heating system, which may include a plurality of radiators, a boiler that provides steam to the plurality of radiators, and a plurality of steam pipes that carry the steam to the plurality of radiators, respectively.

The method of FIG. 11 includes providing a plurality of steam-air vents for the plurality of radiators, respectively, in step S1110, providing a plurality of temperature sensors distributed throughout a predetermined zone of the building in which the plurality of radiators are provided, in step S1120, providing at least one thermostat-controller configured to receive user input of a desired temperature schedule for the predetermined zone, in step S1130, and selectively controlling the plurality of steam-air vents via the at least one thermostat-controller to control an amount of steam distributed to the plurality of radiators based on temperatures sensed by the plurality of temperature sensors and the desired temperature schedule, in step S1140. Step 1140 involves continuously monitoring the plurality of temperature sensors and selectively controlling the plurality of steam air vents based on the sensed temperatures and a temperature schedule set by a user for the predetermined zone in which the plurality of radiators are provided, to obtain a desired heating behavior for the zone, as discussed above with respect to the steam distribution control system according to embodiments disclosed herein.

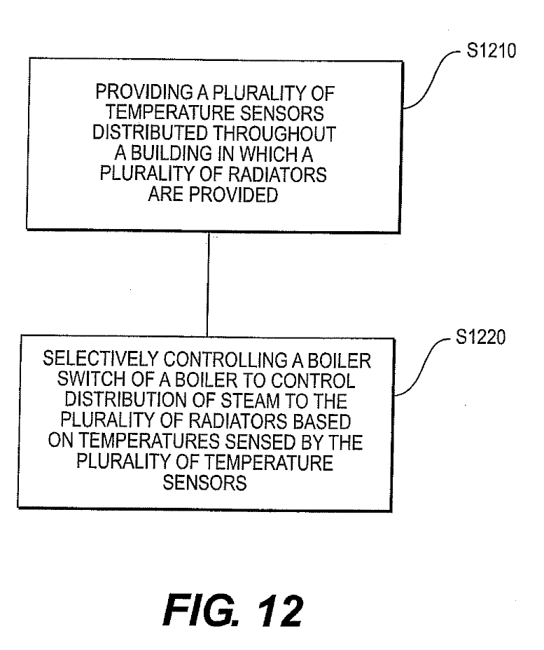

FIG. 12 is a flow chart of a steam distribution control method for a steam heating system according to another embodiment. The steam distribution control method of FIG. 12 may be retrofitted or adapted for an existing steam heating system, which may include a plurality of radiators, a boiler that provides steam to the plurality of radiators, and a plurality of steam pipes that carry the steam to the plurality of radiators, respectively. The steam heating system may further include a boiler switch provided for the boiler.

The method of FIG. 12 includes providing a plurality of temperature sensors distributed throughout a building in which the plurality of radiators are provided, in step S1210, and selectively controlling a boiler switch of the boiler to control distribution of steam to the plurality of radiators based on temperatures sensed by the plurality of temperature sensors, in step S1220. Step 1220 involves continuously monitoring the plurality of temperature sensors and selectively controlling the boiler switch based on the sensed temperatures and a temperature schedule set by a user for a predetermined zone(s) in which the plurality of radiators are provided, to obtain a desired heating behavior for the zone(s), as discussed above with respect to the steam distribution control system according to embodiments disclosed herein.

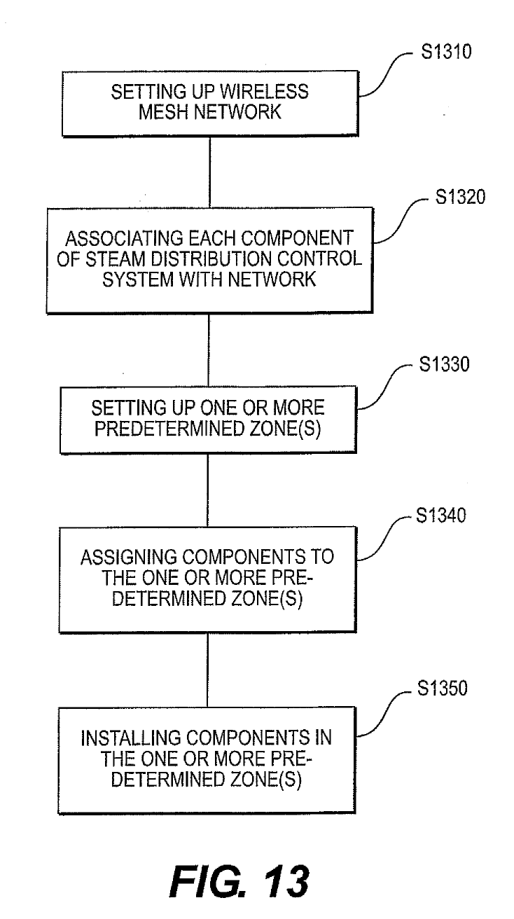

The steam distribution control system for a steam heating system according to embodiments disclosed herein is easy to install. FIG. 13 is a flow chart of an installation method for a steam distribution control system according to an embodiment. The installation method of FIG. 13 may involve retrofitting the steam distribution system according to embodiments disclosed herein to an existing steam heating system. The steam heating system may include a plurality of radiators, a boiler that provides steam to the plurality of radiators, and a plurality of steam pipes that carry the steam to the plurality of radiators, respectively. The boiler may include a boiler switch.

To install the steam distribution control system according to embodiments disclosed herein, a wireless mesh network is first set up, in step S1310. Next, each component or device of the steam distribution control system is associated with the wireless mesh network, in step S1320. Then, one or more zone(s) are set up, in step S1330, and the various components or devices (not including the central controller) are assigned to the one or more zone(s), in step S1340. The components or devices are then installed in the respective zone(s), in step S1350. The steam heating system is then ready for activation and may receive input of desired temperature schedules for each zone(s).

Once the steam distribution control system according to embodiments disclosed herein has been installed, a site has a wireless mesh network. Other functions may then be piggy-backed over the network. Once such example is a wireless front door access system. This would not require a dedicated phone line to call a telephone linked to the apartment, the typical means used today. It would allow a voice intercom to the front door of the building. It would also allow the administrator to “broadcast” messages to all (or some) units in the building. Another is integrating wireless smoke detectors with the larger hard-wired fire system.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A steam distribution control system for a steam heating system, the steam heating system comprising a plurality of radiators, a boiler that provides steam to the plurality of radiators, and a plurality of steam pipes that carry the steam to the plurality of radiators, respectively, the steam distribution control system comprising:
a plurality of steam-air vents provided at the plurality of radiators, respectively; and
a central controller in communication with the plurality of steam-air vents that selectively controls the plurality of steam-air vents to control an amount of steam distributed into each of the plurality of radiators.

2. The steam distribution control system of claim 1, wherein the central controller selectively controls the plurality of steam-air vents to vary a flow of steam into the plurality of radiators through the plurality of steam-air vents, respectively.

3. The steam distribution control system of claim 1, wherein the central controller wirelessly communicates with the plurality of steam-air vents.

4. The steam distribution control system of claim 1, wherein the steam distribution control system is configured to be retrofitted to an existing steam heating system.

5. The steam distribution control system of claim 1, further comprising a plurality of temperature sensors, wherein the central controller is in communication with the plurality of temperature sensors and selectively controls the plurality of steam-air vents to control an amount of steam distributed into each of the plurality of radiators based on temperatures sensed by the plurality of temperature sensors.

6. The steam distribution control system of claim 5, wherein the central controller wirelessly communicates with the plurality of steam-air vents and the plurality of temperature sensors.

7. The steam distribution control system of claim 5, wherein the plurality of temperature sensors comprises one or more indoor temperature sensors and one or more outdoor temperature sensors.

8. The steam distribution control system of claim 5, wherein the plurality of radiators are distributed throughout a building in a plurality of zones, and the central controller is configured to control distribution of steam to the plurality of zones.

9. The steam distribution control system of claim 8, wherein the central controller is configured to receive input of a temperature schedule for each of the plurality of zones and control the distribution of steam to the plurality of zones based on the temperatures sensed by the plurality of temperature sensors and the temperature schedules input for each of the plurality of zones.

10. The steam distribution control system of claim 9, wherein the central controller is configured to receive input of the temperature schedule for each of the plurality of zones through at least one of the following:
an user interface provided at the central controller;
a thermostat provided within a respective zone of the plurality of zones; or
a desktop application provided in a computer in communication with the central controller.

11. The steam distribution control system of claim 5, wherein the central controller is configured to monitor failures or misuse of the steam distribution control system and issue a warning or alert to a user.

12. The steam distribution control system of claim 11, wherein the warning or alert is issued by email or text message.

13. The steam distribution control system of claim 11, wherein the warning or alert includes maintenance needs.

14. The steam distribution control system of claim 11, wherein the warning or alert includes an indication that one or more window(s) or door(s) is open.

15. The steam distribution control system of claim 5, further comprising:
one or more thermostats in communication with the central controller, the one or more thermostats each comprising a user interface device.

16. The steam distribution control system of claim 1, wherein the central controller comprises a user interface device.

17. The steam distribution control system of claim 1, wherein the central controller comprises:
a microcomputer;
a memory configured to store data; and
a wireless mesh network interface device configured to allow the central controller to wirelessly communicate with the plurality of first steam-air vents.

18. The steam distribution control system of claim 17, wherein the central controller further comprises a desktop application interface device that allows the central controller to communicate with a desktop application of a computer.

19. The steam distribution control system of claim 17, wherein the central controller further comprises at one of an Internet interface device, a memory card interface device, or a short range wireless device interface device.

20. The steam distribution control system of claim 1, wherein each of the plurality of steam-air vents comprises a variable flow vent.

21. The steam distribution control system of claim 20, wherein the vent is solenoid activated.

22. The steam distribution control system of claim 20, wherein the vent is powered by a battery.

23. The steam distribution control system of claim 1, wherein the steam heating system further comprises a boiler switch, wherein the boiler switch is controlled by the central controller to turn on or off the boiler.

24. The steam distribution control system of claim 1, wherein the plurality of steam-air vents each includes a pump that evacuates air out of the respective radiator.

25. A steam distribution control system for a steam heating system, the steam heating system comprising a plurality of radiators, a boiler that provides steam to the plurality of radiators, and a plurality of steam pipes that carry the steam to the plurality of radiators, respectively, the steam distribution control system comprising:
a plurality of steam-air vents provided for the plurality of radiators, respectively;
a plurality of temperature sensors distributed throughout a predetermined zone of a building in which the plurality of radiators are provided; and
at least one thermostat-controller configured to receive user input of a desired temperature schedule for the predetermined zone, wherein the at least one thermostat communicates with the plurality of steam-air vents and the plurality of temperature sensors and selectively controls the plurality of steam-air vents to control an amount of steam distributed to the plurality of radiators based on temperatures sensed by the plurality of temperature sensors and the desired temperature schedule.

26. A steam distribution control system for a steam heating system, the steam heating system comprising a plurality of radiators, a boiler that provides steam to the plurality of radiators, and a plurality of steam pipes that carry the steam to the plurality of radiators, respectively, the steam distribution control system comprising:
a plurality of temperature sensors distributed throughout a building in which the plurality of radiators are provided; and
a central controller that communicates with the boiler switch and the plurality of temperature sensors and selectively controls a boiler switch of the boiler to control distribution of steam to the plurality of radiators based on temperatures sensed by the plurality of temperature sensors.

27. A method of controlling distribution of steam for a steam heating system, the steam heating system comprising a plurality of radiators distributed through a building, a boiler that provides steam to the plurality of radiators, and a plurality of steam pipes that carry the steam to the plurality of radiators, respectively, the method comprising:
providing a steam-air vent at each of the plurality of radiators; and
selectively controlling the plurality of steam-air vents to control an amount of steam distributed into each of the plurality of radiators.

28. The method of claim 27, wherein selectively controlling the plurality of steam-air vents comprises selectively controlling the plurality of steam-air vents via a central controller in wireless communication with the plurality of steam-air vents.

29. The method of claim 27, further comprising:
providing a plurality of temperature sensors, wherein selectively controlling the plurality of steam-air vents comprises selectively controlling the plurality of steam-air vents to control an amount of steam distributed to each of the plurality of radiators based on temperatures sensed by the plurality of temperature sensors.

30. The method of claim 29, wherein selectively controlling the plurality of steam-air vents comprises selectively controlling the plurality of steam-air vents via a central controller in wireless communication with the plurality of steam-air vents and the plurality of temperature sensors.

31. The method of claim 27, wherein selectively controlling the plurality of steam-air vents to control an amount of steam distributed to each of the plurality of radiators comprises controlling the plurality of steam-air vents to vary a flow of steam into the plurality of radiators through the plurality of steam-air vents, respectively.

32. The method of claim 27, further comprising retrofitting the plurality of steam-air vents to an existing steam heating system.

33. The method of claim 27, wherein the plurality of steam-air vents each including a pump that evacuates air out of the respective radiator.

34. A method of controlling distribution of steam for a steam heating system, the steam heating system comprising a plurality of radiators distributed within a predetermined zone of a building, a boiler that provides steam to the plurality of radiators, and a plurality of steam pipes that carry the steam to the plurality of radiators, respectively, the method comprising:
providing a plurality of steam-air vents for the plurality of radiators, respectively;
providing a plurality of temperature sensors distributed throughout the predetermined zone of the building;
providing at least one thermostat configured to receive user input of a desired temperature schedule for the predetermined zone; and
selectively controlling the plurality of steam-air vents via the at least one thermostat to control an amount of steam distributed to the plurality of radiators based on temperatures sensed by the plurality of temperature sensors and the desired temperature schedule.

35. A method of controlling distribution of steam for a steam heating system, the steam heating system comprising a plurality of radiators, a boiler that provides steam to the plurality of radiators, respectively, and a plurality of steam pipes that carry the steam to the plurality of radiators, respectively, the method comprising:
providing a plurality of temperature sensors distributed throughout a building in which the plurality of radiators are provided; and
selectively controlling a boiler switch of the boiler to control distribution of steam to the plurality of radiators based on temperatures sensed by the plurality of temperature sensors.

36. A installation method for retrofitting a steam distribution control system to an existing steam heating system, the steam heating system comprising a plurality of radiators, a boiler that provides steam to the plurality of radiators, and a plurality of steam pipes that carry the steam to the plurality of radiators, respectively, the installation method comprising:
setting up a wireless mesh network;
associating each component of the steam distribution control system with the wireless mesh network;
setting up one or more predetermined zones;
assigning certain components to the one or more predetermined zones; and
installing the certain components in the one or more predetermined zones.

37. The installation method of claim 36, further comprising:
setting up a temperature schedule for each of the one or more predetermined zones.

38. The installation method of claim 37, wherein the components of the steam distribution control system include:
a plurality of first steam-air vents provided for the plurality of radiators, respectively; and
a central controller that wirelessly communicates with the plurality of first steam-air vents and selectively controls the plurality of first steam-air vents to control an amount of steam distributed to each of the plurality of radiators.

39. The installation method of claim 38, wherein the components of the steam distribution control system further include:
a plurality of temperature sensors, wherein the central controller wirelessly communicates with the plurality of temperature sensors and selectively controls the plurality of first steam-air vents to control an amount of steam distributed to each of the plurality of radiators based on temperatures sensed by the plurality of temperature sensors

40. The installation method of claim 38, wherein the components of the steam distribution control system further include:
a plurality of second steam-air vents provided for the plurality of radiators, respectively, the plurality of second steam-air vents each including a pump that evacuates air out of the respective radiator.

41. The installation method of claim 37, wherein the components of the steam distribution control system include:
a plurality of steam-air vents provided for the plurality of radiators, respectively;
a plurality of temperature sensors distributed throughout a predetermined zone of a building in which the plurality of radiators are provided; and
at least one thermostat configured to receive user input of a desired temperature schedule, wherein the at least one thermostat wirelessly communicates with the plurality of steam-air vents and the plurality of temperature sensors and selectively controls the plurality of steam-air vents to control an amount of steam distributed to the plurality of radiators based on temperatures sensed by the plurality of temperature sensors and the desired temperature schedule.

42. The installation method of claim 39, wherein the components of the steam distribution control system include:
a plurality of temperature sensors distributed throughout a building in which the plurality of radiators are provided; and
a central controller that wirelessly communicates with the boiler switch and the plurality of temperature sensors and selectively controls a boiler switch of the boiler to control distribution of steam to the plurality of radiators based on temperatures sensed by the plurality of temperature sensors.
